(19) United States
(12) Patent Application Publication
(10) Pub. No.: US 2014/0130397 A1
(43) Pub. Date: May 15, 2014

(54) Eyelet Or Line Guide Element For A Fishing Rod Or Pole

(71) Applicant: Cornelius Johannes Annandale, Brisbane (AU)

(72) Inventor: Cornelius Johannes Annandale, Brisbane (AU)

(21) Appl. No.: 14/127,601

(22) PCT Filed: Jun. 21, 2012
(86) PCT No.: PCT/AU2012/000716

§ 371 Date: Dec. 23, 2013

(30) Foreign Application Priority Data
Jun. 21, 2011 (AU) 2011902409

(51) Int. Cl. A01K 87/04

(52) U.S. Cl. CPC A01K 87/04
USPC 43/24

(57) ABSTRACT

This invention relates to improved fishing rod components, more particularly an improved eyelet or line guide for a fishing rod or pole and a method of manufacturing the same. The invention resides in a fishing rod or pole that comprises a plurality of longitudinally disposed attachment means secured and spaced apart along a substantially identical axis of the rod or pole; and a line guide or eyelet that is pivotally engaged with each of the plurality of longitudinally disposed attachment means for guiding a fishing line there-through, wherein the pivoting of the line guide or eyelet facilitates storage, transport and use of the rod or pole without damaging the line guide or eyelet.

### FIELD OF THE INVENTION

This invention relates to improved fishing rod components, more particularly an improved eyelet or line guide for a fishing rod or pole and a method of manufacturing the same. A plurality of swivelling eyelets or line guides (10) for a fishing rod are provided, which are formed from a suitable material and configured to pivotally engage a plurality of attachment means disposed along the elongated length of the fishing rod or pole.

### BACKGROUND OF THE INVENTION

Fishing is an ancient practice adopted by cultures around the world and dates back thousands of years. A common article or piece of tackle that is used in the practice of fishing is known as a fishing rod or fishing pole, which commonly includes a predetermined length of fishing line that is attached to an elongated flexible rod or pole and terminates at one end with a hook that is used to catch the fish.

An important aspect of a fishing rod or pole in its construction is the inclusion of a plurality of line guides or eyelets that are disposed along the length of the elongated rod or pole. The line guides or eyelets of a finishing rod or pole enable the finishing line that is attached to the rod to be threaded through them. In this regard, prior art line guides or eyelets for use on a fishing rod or pole have various configurations and vary in size and weight to accommodate the intended use of the fishing rod or pole, and are commonly secured via discrete attachment portions to the rod or pole at spaced intervals.

For instance, WO97/49281 (hereinafter the 1/281 Publication“) discloses an eyelet that is spaced at discrete locations along the length of a fishing rod or float, which are designed to quickly and easily enable the fishing line to be removed and reattached. The eyelet of the '281 Publication consists of a length of sheet material having opposite end portions and an aperture therebetween, where one end portion thereof is dimensioned and folded back upon itself so that it passes through the aperture to form a loop. The eyelet has a pair of legs 11 and 12 that extend to attachment portions 13 and are secured to the shaft of the fishing rod or the stem of a float.

WOOO/16613 (hereinafter the '613 Publication”) also discloses novel and improved fishing rod guides, tops and hook keepers. As shown in FIG. 2 of the '613 Publication, the guide 12 includes one or more base support portions 20 of elongated configuration that extend longitudinally and can be readily secured to the rod. A line engaging guide ring portion 22 is then supported in a somewhat elevated position relative to the base portions 20 by one or more leg members 24 that extend from each base support member. The guide therein is disclosed as being fabricated by a suitable shape memory alloy, such as Nickel Titanium Alloys, that enables the original shape to return after getting caught on trees or bushes during transportation.

However, a common problem that is encountered with prior art eyelets or line guides is that during transportation or storage they can be inadvertently or accidently bent or broken. In particular, line guides or eyelets are currently manufactured from various types of stainless steel or alloy, or other suitable material that are commonly brittle in nature (i.e. fibreglass) and are secured via an attachment portion directly to the elongated portion of the rod or pole. In this regard, as current line guides or eyelets are secured to the elongated rod or pole, if they are impacted with a sufficient force during storage, transportation or even during use they can become dislodged or even bent. Moreover, as the guides or eyelets are secured to the rod, the profile of the rod or pole during storage is cumbersome, which can be disadvantageous in small areas such as boats and other vehicles.

Another problem with current eyelets or line guides is that during manufacture they generally require a surface coating so as to enhance their durability to wear and to decrease the friction produced when in contact with the fishing line that is guided through them. This coating process dramatically increases the costs and time to manufacture a fishing rod or pole, and it is a common occurrence that during use or transportation the coating can become chipped and impede on smooth guiding of the fishing line. While the '613 Publication attempts to solve this problem by using a material that has a low coefficient of friction and without the need of a coating or surface treatment, as the guides are secured in a non-movable manner to the elongated rod, during casting the smooth drawing of the line from the reel can still be compromised.

### OBJECT OF THE INVENTION

It is therefore the object of the invention to ameliorate some or all of the above disadvantages of the prior art by providing a novel and inventive eyelet or line guide for use with a fishing rod or pole.

### STATEMENT OF INVENTION

In one aspect, the invention resides in a fishing rod or pole (12), comprising:
a plurality of longitudinally disposed attachment means (32) secured and spaced apart along a substantially identical axis of the rod or pole (12);
a terminal attachment means (30) secured to a distal end of the rod or pole; and a line guide or eyelet (10) that is pivotally engaged with each of the plurality of longitudinally disposed attachment means (32) and terminal attachment means (30), for guiding a fishing line there-through,
wherein the pivoting of the line guide or eyelet (10) facilitates storage, transport and use of the rod or pole without damaging the line guide or eyelet (10).

Preferably, the line guide or eyelets (10) are configured to be removably engaged with the longitudinally disposed attachment means (32) and the terminal attachment means (30).

More preferably, the line guide or eyelet (10) is at least one enclosed loop of a stainless steel alloy or other suitable material that is capable of guiding a fishing line there-through. However, in other non-limiting embodiments, the line guide or eyelets (10) are square shaped, oval shaped or another suitable oblique shape.

In another aspect of the invention, a line guide or eyelet (10) for use in a fishing rod or pole is provided, wherein the line guide or eyelet (10) is configured to be removable and pivotally engaged with a plurality of longitudinally disposed attachment means (32) and a terminal attachment means (30) secured on the fishing rod or pole, and is configured to guide a fishing line there-through.

### BRIEF DESCRIPTION OF THE DRAWINGS

In order for the invention to be better understood reference will now be made to the accompanying drawings, wherein:

FIG. 1 is a schematic plan view of a fishing rod mounting various components produced in accordance with the present invention;

FIG. 2 is an enlarged perspective view of a preferred terminal attachment means and line guide or eyelet used on the rod of FIG. 1;

FIG. 3 is an is an enlarged perspective view of a preferred longitudinally disposed attachment means and eyelets or line guides used on the rod of FIG. 1.

### DETAILED DESCRIPTION OF THE DRAWINGS

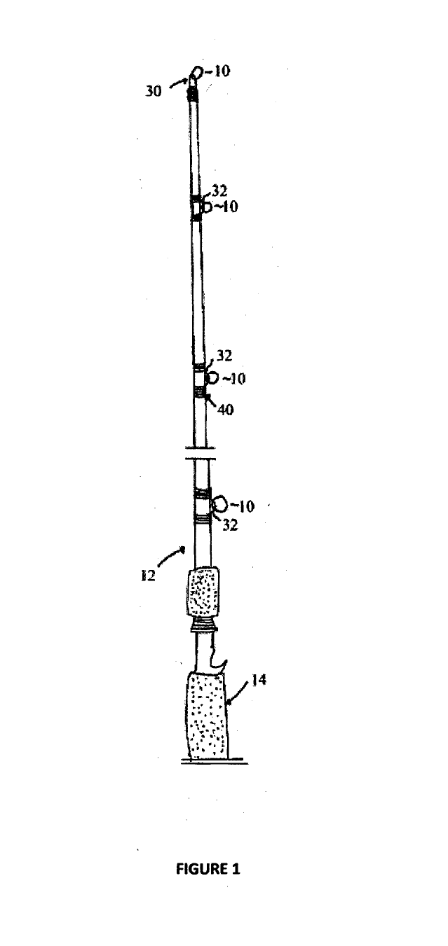

Referring now to FIG. 1 there is shown a fishing rod (12) having a proximal and distal end. The fishing rod (12) is an elongated rod or pole generally having a handle grip means (14) secured to the proximal end thereof that also provides a means for securing a conventional fishing reel thereto. The design and material used in the manufacture of the fishing rod (12) for use in the present invention is not overly limited, and can be of any known design and production method. In this regard, techniques and materials used in the manufacture of a suitable fishing rod are well known to those skilled in the art, and examples of such can be found in WO2004/064512, WO2004/064510 and WO2003/092372, the disclosure of which is incorporated herein.

As also shown in FIG. 1, a plurality of attachment means (32) are longitudinally disposed at spaced intervals along the length of the fishing rod (12) and a terminal attachment means (30) is attached to the distal end of the fishing rod or pole (12). A line guide or eyelet (10) that is capable of receiving and guiding a finishing line there-through is pivotably engaged with each of the longitudinally disposed attachment means (32) and the terminal attachment means (30).

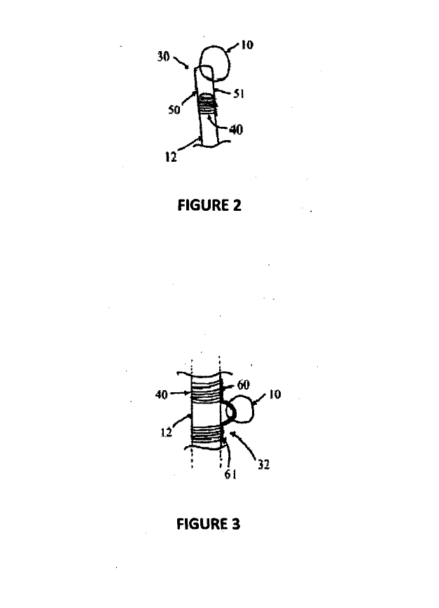

Moving now to FIG. 2, an enlarged view of the terminal attachment means (30) and a corresponding line guide or eyelet (10) is shown. In this preferred embodiment, the terminal attachment means (30) is preferably a “U-shaped” portion of a stainless steel alloy that has two corresponding elongated arms (50 and 51) that align is close communication with the contour of the distal end of the fishing rod or pole (12). Preferably, pole lashings (40), which are formed by the concentric winding of any suitable fibre known to those skilled in the art around the outer peripheral edge of the fishing rod or pole (12) and the elongated arms (50 and 51) of the terminal attachment means (30), tightly secures the terminal attachment means (30) to the fishing rod or pole (12).

However, those skilled in the art would understand that any other type of attachment means of the attachment means could be used without departing from the spirit of the present invention. For instance, it is envisaged that a cap member (not shown) could be used to be adhered to the tip of the rod to provide a physical attachment (via soldering or the like) for the attachment means.

In a preferred embodiment, the line guide or eyelet (10) is at least one enclosed loop of a stainless steel alloy or other suitable material that is capable of guiding a fishing line therethrough. An important feature of the present invention, however, is the ability of the line guide or eyelet (10) to pivot or swivel around the terminal attachment means (30) and/or a longitudinally disposed attachment means (32) to which it is engaged with. Those skilled in the art would appreciate that the shape, size and/or material used in the fabrication of the line guide or eyelet (10) is not overly limited, so long as such is capable of maintaining its shape and maintaining its pivotable or swivel communication with the longitudinally disposed attachment means (32) or the terminal attachment means (30). For example, the line guide or eyelet (10) can be, but not limited to, in the shape of a ring, square, oval or other suitable oblique shape.

In a more preferred embodiment, the line guide or eyelets (10) are configured to be removably engaged with the longitudinally disposed attachment means (32) and the terminal attachment means (30). For example, the line guide or eyelets (10) can be, but not limited to, a split ring configuration (e.g. like that of a conventional “key-ring”), a lockable caribena type configuration, or any other suitable configuration that enables the line guide or eyelets (10) to be removably engaged with an attachment means. In this manner, the line guide or eyelets (10) of the present invention can be removed from the rod, if required, so as to facilitate replacement or substitution thereof to accommodate the varying needs of the user.

Moving now to FIG. 3, which shows an enlarged view of the longitudinally disposed attachment means (32) and a corresponding line guide or eyelet (10), each of the longitudinally disposed attachment means (32) preferably have two corresponding elongated arms (60 and 61) longitudinally aligned along the axis of the fishing rod or pole (12). An elevated portion is provided between the two corresponding elongated arms (60 and 61), as clearly shown in FIG. 3. As discussed previously, pole lashings (40), which are formed by the concentric winding of any suitable fibre known to those skilled in the art tightly secures each of the longitudinally disposed attachment means (32) to the fishing rod or pole (12). It is appreciated by those skilled in the art that any other known method of securing an attachment means to the rod or pole could be used without departing from the teachings of the present invention.

As shown best in FIGS. 1 and 3, each of the plurality of longitudinally disposed attachment means (32) are each configured to engage a line guide or eyelet (10), which is capable of pivoting or swivelling around the longitudinally disposed attachment means (32) to which it is engaged with. As discussed previously, those skilled in the art would appreciate that the shape, size and/or material used in the fabrication of the line guide or eyelet (10) is not overly limited, so long as such is capable of maintaining its shape and maintaining its pivotable or swivel communication with the longitudinally disposed attachment means (32) or the terminal attachment means (30), as this is key to present invention.

As the line guide or eyelets (10) are capable of pivoting or swivelling around the terminal attachment means (30) or longitudinally disposed attachment means (32) it is engaged with, during transportation and/or storage the profile of the fishing rod or pole can be substantially reduced to enable safe storage on a flat surface. Specifically, the line guide or eyelets (10) under their own weight are permitted to fall to the contour of the rod or pole. More importantly, however, as the line guide or eyelets (10) are capable of pivoting or swivelling, the durability of such is substantially enhanced as the pivoting or swivelling action acts to absorb most destructive forces that may accidently be applied to the elongated fishing rod or pole.

In addition to the above advantage of the present invention, as the line guide or eyelets (10) are capable of pivoting or swivelling around its attachment with the terminal attachment means (30) or longitudinally disposed attachment means (32), during casting or retrieving the frictional force resulting from the interaction with the inner surface of the line guide or eyelets (10) and the fishing line guiding there-through is substantially reduced. Specifically, the swivelling or pivoting action enables the line guides or eyelets (10) to substantially follow the attitude of the fishing line during operation, and thus decreases the possibility of the fishing line breaking or deteriorating due to frictional forces.

It will of course be realised that while the foregoing has been given by way of illustrative example of this invention, all such and other modifications and variations thereto as would be apparent to persons skilled in the art are deemed to fall within the broad scope and ambit of this invention as is herein set forth.

In additional, it will be appreciated that in the specification the terms “comprising” and “containing” shall be understood to have a broad meaning similar to the term “including” and will be understood to imply the inclusion of a stated integer or step or group of integers or steps but not the exclusion of any other integer or step or group of integers or steps. This definition also applies to variations on the terms “comprising” and “containing” such as “comprise”, “comprises”, “contain” and “contains”.

What is claimed is:

1. A fishing rod or pole (12), comprising:
a plurality of longitudinally disposed attachment means (32) secured and spaced along a substantially identical axis of the rod or pole (12);
a terminal attachment means (30) secured to a distal end of the rod or pole; and
a line guide or eyelet (10) that is pivotally engaged with each of the plurality of longitudinally disposed attachment means (32) and terminal attachment means (30), for guiding a fishing line there-through.

2. The fishing rod or pole of claim 1, wherein the line guide or eyelets (10) are configured to be removably engaged with the longitudinally disposed attachment means (32) and the terminal attachment means (30).

3. The fishing rod or pole of claim 1 or 2, wherein the line guide or eyelet (10) is at least one enclosed loop of a stainless steel alloy or other suitable material that is capable of guiding a fishing line there-through.

4. A line guide or eyelet (10) for use in a fishing rod or pole, wherein the line guide or eyelet (10) is configured to be removably and pivotally engaged with a plurality of longitudinally disposed attachment means (32) and a terminal attachment means (30) secured on the fishing rod or pole, and is configured to guide a fishing line there-through.

5. The line guide or eyelet (10) of claim 4, wherein the line guide or eyelet (10) is an enclosed loop of a stainless steel alloy or other suitable material that is capable of guiding a fishing line there-through.
